(19) United States
(12) Patent Application Publication
(10) Pub. No.: US 2016/0028052 A1
(43) Pub. Date: Jan. 28, 2016

(54) METHODS OF ATTACHING TWO LAYERS TOGETHER USING A RIVET FORMED OF SEALING MATERIAL AND ARTICLES OF MANUFACTURE MADE THEREBY

(71) Applicant: SOLICORE, INC., Lakeland, FL (US)

(72) Inventors: Daniel TILLWICK, Saint Petersburg, FL (US); Neil KREITMAN, Floral City, FL (US)

(21) Appl. No.: 14/775,147

(22) PCT Filed: Mar. 12, 2014
(86) PCT No.: PCT/US14/24101

§ 371 Date: Sep. 11, 2015

Related U.S. Application Data
(60) Provisional application No. 61/777,780, filed on Mar. 12, 2013.

(51) Int. Cl. H01M 2/08; H01M 10/052; H01M 10/0585

(52) U.S. Cl. CPC H01M 2/08; H01M 10/0585; H01M 10/052

(57) ABSTRACT

A method of attaching first and second layers together using a sealing material which flows under heat and pressure is provided. The method involves applying heat and pressure to a laminate comprising the first layer, the second layer and the sealing material wherein a first portion of the second layer having one or more apertures is between the heat sealing material and the first layer. Under heat and pressure, the sealing material flows into and through the one or more apertures in the second layer and contacts the underlying first layer thereby forming a rivet which attaches the first and second layers together.

This application claims the benefit of Provisional U.S. Patent Application Ser. No. 61/777,780, filed on Mar. 12, 2013, pending, which is incorporated by reference herein in its entirety.

### TECHNICAL FIELD

This application relates to a method of attaching two layers together using a material which flows under heat and pressure and to articles of manufacture made thereby.

### BACKGROUND

Various methods of attaching layers of material together are known. For example, adhesive bonding which involves placing an adhesive between the layers is commonly used to attach two layers together. However, the adhesive layer has a thickness which increases the thickness of the bonded article at the joint between the two layers. This increased thickness can be undesirable in applications where the thickness of the article is desired to be kept at a minimum. In addition, if the layers being secured together are electrically conductive, the adhesive may affect electrical continuity between the two layers. Moreover, a nonconductive adhesive would form an electrically insulating layer between two conductive layers. Other attachment methods are limited by the types of materials which can be joined or require additional process steps which complicate and add to the cost of the manufacturing process.

Accordingly, there still exists a need for improved methods of securing materials together.

### SUMMARY

According to a first embodiment, a method of attaching a first layer to a second layer is provided which comprises:

applying heat and pressure to a laminate comprising the first layer, the second layer and a sealing material, wherein a first portion of the second layer comprises one or more apertures and wherein the first portion of the second layer is between the sealing material and the first layer;

wherein the sealing material flows into and through the one or more apertures in the second layer under the heat and pressure and contacts the underlying first layer thereby attaching the first and second layers together.

According to a second embodiment, an article of manufacture is provided which comprises:

a first layer;

a second layer on and in contact with the first layer wherein the second layer comprises one or more apertures; and

a sealing material on the second layer opposite the first layer, in the one or more apertures in the second layer and on surfaces of the first layer exposed by the one or more apertures, wherein the first and second layers are attached together by the sealing material.

According to a third embodiment, a battery is provided which comprises:

a battery cell having a periphery, the battery cell comprising an anode, a cathode and an electrolyte between the anode and cathode;

an anode tab comprising a first portion in electrical contact with the anode and a second portion extending beyond the periphery of the cell;

a cathode tab comprising a first portion in electrical contact with the cathode and a second portion extending beyond the periphery of the cell;

wherein the first portion of the anode tab comprises one or more apertures filled with a sealing material thereby securing the anode tab to an underlying layer of the anode; and

wherein the first portion of the cathode tab comprises one or more apertures filled with a sealing material thereby securing the cathode tab to an underlying layer of the cathode.

The sealing material can be a hot melt adhesive. According to some embodiments, the sealing material comprises a polymer selected from the group consisting of acrylics, ethylene acrylic acid (EAA) copolymers, ethylene and ethyl acrylate (EEA) copolymers, ethylene methacrylic acid (EMA) copolymers, ethylene vinyl acetate (EVA) copolymers, polymethyl acrylate (PMA), acrylonitrite, vinyl chloride polypropylene (VCPP) copolymers, acrylic nitrile-butadiene-styrene (ABS) copolymers, polyethylene (PE), polypropylene (PP) and mixtures thereof.

### BRIEF DESCRIPTION OF THE DRAWINGS

FIG. 1 is a schematic showing a method of attaching two layers together using a rivet formed of a sealing material wherein the first and second layers and the heat sealing material are shown before the application of heat and pressure.

FIG. 2 is a schematic showing a method of attaching two layers together using a rivet formed of a sealing material wherein the first and second layers are shown after the application of heat and pressure wherein the heat sealing material has flown through the aperture in the second layer thereby attaching the first and second layers together.

### DETAILED DESCRIPTION

A method of attaching first and second layers together is provided. The method involves using a sealing material which flows under heat and pressure into an aperture in one of the layers of material thereby forming a polymer rivet which attaches the layers together. The method may be used to mechanically attach two or more films to one another. If the films are electrically conductive, mechanical adhesion can be obtained while maintaining electrical continuity between them.

The method involves forming one or more apertures in one of the layers of material. A heat sealable material which flows under heat and pressure is positioned adjacent the one or more apertures on one side of the first layer. The second layer of material is positioned on the opposite side of the first layer. Heat and pressure are applied to the laminate such that the heat sealable material flows through the one or more apertures thereby attaching the first and second layers together.

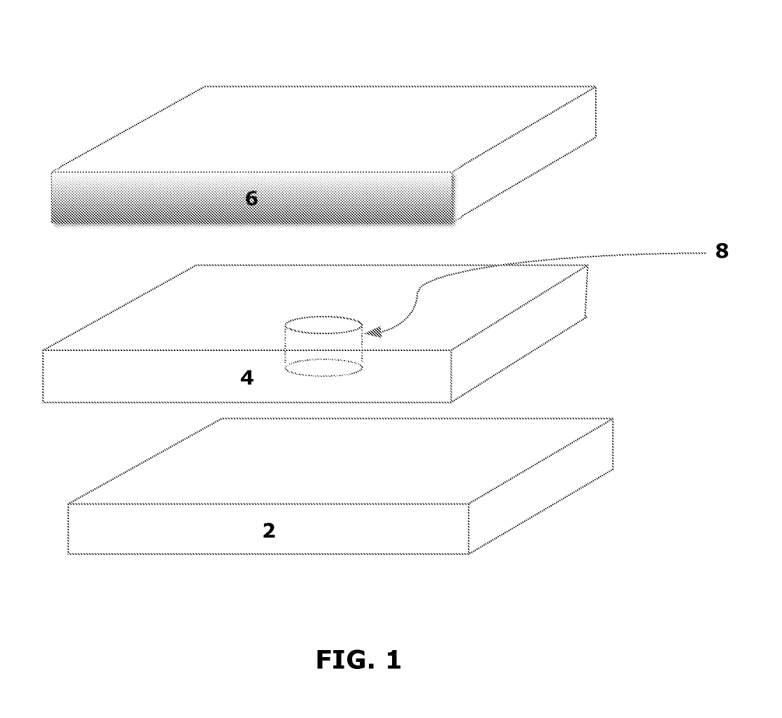

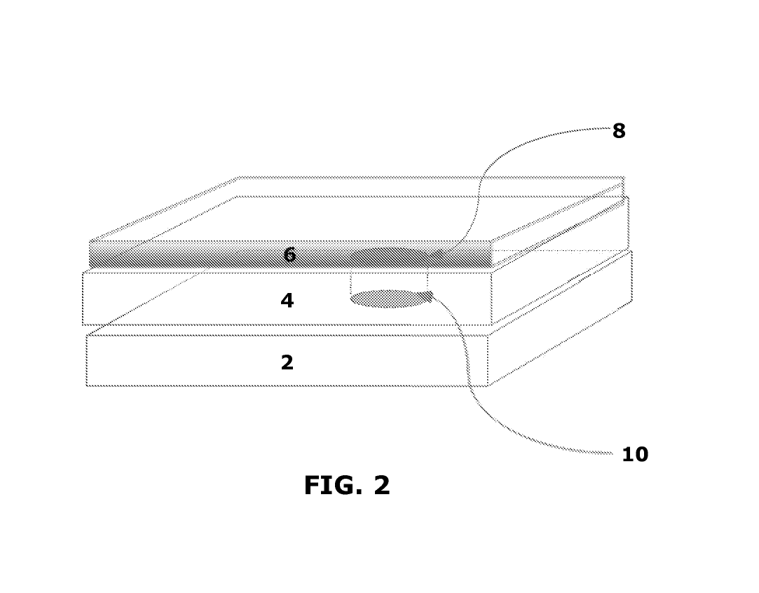

The method is illustrated in FIGS. 1 and 2. In particular, FIG. 1 shows the layers before the application of heat and pressure. As shown in FIG. 1, a second layer 4 comprising an aperture 8 is positioned between a first layer 2 and a layer of a sealing material 6. Although a single aperture is shown, additional apertures can be used. As shown in FIG. 2, upon application of heat and pressure, the sealing materials flows into and through aperture 8 in second layer 4 and contacts the first layer 2 thereby filling the aperture and forming a rivet 10 of the sealing material.

Apertures do not need to be formed in each of the layers being attached. The adhesive properties of the sealing material are used to secure the rivet to one or more layers.

According to one embodiment, two film layers are attached by creating one or more apertures in one of the films. The second film is left solid in the region underlying the one or more apertures. The two films being attached are placed beneath a heat sealable lidding or packaging foil comprising a heat sealing inner layer. The stacked material is laminated under pressure and sufficient heat to allow the material of the heat sealing layer to flow. The material of the heat sealing layer flows into the one or more apertures and bonds to the solid film layer below it, thus forming a rivet.

The first and second layers can be electrically conductive layers such as metallic foil layers. The method allows for electrical continuity to be maintained between the first and second layers.

According to some embodiments, the method can be used to attach a battery terminal or tab to the anode or cathode in a battery. A battery is provided comprising an anode layer, a cathode layer and an electrolyte layer disposed between the anode and cathode layers. An anode current collector tab for delivering electrical energy from the battery cell to an external device is attached to and extends outwardly beyond the periphery of the anode layer. A cathode current collector tab is attached to and extends outwardly beyond the periphery of the cathode. Batteries of this type are described in U.S. patent application Ser. No. 12/466,900, filed on May 15, 2009 and published as U.S. Patent Application Publication No. 2009/0286150 A1, which is incorporated by reference herein in its entirety. According to some embodiments, the cathode current collector tab and/or the anode current collector tab are attached to the respective cathode and anode layer or to a current collector sheet disposed adjacent to the respective anode and cathode layer using a polymer rivet as described herein.

The anode current collector tab and the cathode current collector can be made from a conductive web or sheet like material. According to some embodiments, the current collector tabs are composed of metal foils such as aluminum, copper, or nickel foils. According to some embodiments, the tabs are made from electrodeposited copper or nickel flashed copper. The current collector tab can be, for example, an electrodeposited copper tab (18 microns). The current collector tabs are desirably thin so that packaging materials may be easily sealed around them. For example, the current collector tabs can have a thickness of no more than about 10 mils and desirably, no more than about 1 mil (where 1 mil=1/1000 inch or 0.0254 millimeters). However, current collector tabs having a thickness outside of these ranges may also be employed. In some embodiments, the current collector tabs may comprise an extension protruding from a larger current collector sheet disposed adjacent an anode or a cathode. According to some embodiments, the tab may comprise a strip of material disposed on, and extending outwardly beyond the edge of, a current collector sheet, an anode or a cathode.

According to some embodiments, the method can be used to secure a battery terminal to a circuit. One aspect of the present invention provides a battery that may be easily installed in a variety of electronic devices without the need to solder or weld the current collector tabs to the circuitry of the device. This aspect of the invention provides a battery that includes at least one current collector tab. For example, the battery may include an anode having an anode current collector tab extending outwardly from its periphery, a cathode having a cathode current collector tab extending outwardly from its periphery, an electrolyte disposed between the anode and the cathode, wherein an aperture is formed in the portion of the anode and/or cathode current collector tabs extending from the cell. In this construction, the method described herein is used to form the electrical connection between each current collector tab and one or more electrical contacts in the device into which the battery is to be installed. This electrical connection eliminates the need to solder or weld the battery tabs in place.

In a preferred embodiment, the battery cell comprises at least two current collector tabs extending from the battery cell. In a preferred embodiment, the battery cell is substantially planar and substantially rectangular, and the current collector tabs extending from the battery cell are substantially planar and substantially rectangular. In a preferred embodiment, the battery comprises a battery cell comprising: (a) an anode, (b) a cathode, (c) an electrolyte disposed between the anode and the cathode; and at least two current collector tabs extending from the battery cell, wherein a first current collector tab is an anode current collector tab extending from the anode, and a second current collector tab is a cathode current collector tab extending from the cathode. The cell can be a substantially rectangular, substantially planar cell with two length sides and two width sides wherein the current collector tabs extend from one width side of the cell. Alternatively, the cell can be a substantially rectangular, substantially planar cell with two length sides and two width sides and the cell comprises at least two current collector tabs extending from one length side of the cell.

The battery cell can include an electrically insulative and moisture and vapor resistant packaging material surrounding the battery cell. The packaging material may be a multilayered packaging material including one or more sealing layers, one or more electrically insulative layers and one or more moisture and/or vapor barrier layers. For example, the outer packaging material may have a binder adhesive coated on at least a portion of its exterior surface to help bind the battery into an electronic device, such as a smart card. The binder adhesive is desirably a heat activated adhesive which activates at temperatures of at least about 100° C. A binder adhesive may also be applied to at least a portion of the interior surface of the packaging material to bind the outer packaging material to the battery cell. This interior binder adhesive can have an activation temperature which is lower than the activation temperature of the exterior binder adhesive. According to some embodiments, the interior binder adhesive can be used to form a polymer rivet between the battery tabs and the anode and cathode layers of the cell. In particular, an aperture can be in a strip of thin metallic film such as a battery terminal. The metallic strip or tab can then be placed on top of a metallic film such as a battery current collector. The two films are placed into a heat sealable pouch comprising a heat sealable inner layer. The assembly is then sealed under heat and pressure. Under heat and pressure, the sealing material in the inner layer of the pouch flows through the aperture in the battery terminal thereby attaching the tab to the underlying current collector.

A single piece of packaging material can be folded over to provide upper and lower packaging materials from a single continuous piece of material. The fold can be on the side of the battery cell opposite the side from which the current collector tabs extend.

The battery can be a lithium metal or lithium ion battery. The battery can be a polymer electrolyte battery. The cell can comprise an electrolyte comprising a soluble polyimide. The electrolyte can be a polymer matrix electrolyte comprising a polyimide, at least one lithium salt and at least one solvent. The lithium salt can be present in a concentration of at least 0.5 moles of lithium per mole of imide ring provided by the polyimide. The polymer matrix electrolyte can be substantially optically clear. The anode can comprise a lithium powder and a polymer binder. The polymer binder can be a high temperature polymer which is heat-resistant. For example, the polymer binder can have a glass transition temperature of at least 100° C., or at least 150° C. The polymer binder can be selected so that it does not react with the lithium powder. According to some embodiments, the polymer binder is a polyimide. According to some embodiments, the lithium powder has an average particle size of no more than about 20 microns. According to some embodiments, the cathode comprises a polyimide, an electronic conductive filler and a metal oxide. According to some embodiments, the electrolyte layer comprises solvent in an amount of about 10 wt. % to about 50 wt. %, and more particularly, about 15 wt. % to about 40 wt. %, and more particularly, about 20 wt. % to about 30 wt. %. The battery can also be a metal hydride (e.g., Ni-MH) or nickel-cadmium (Ni—Cd) battery. The battery may have solid, liquid or polymer electrolytes.

Suitable materials that may be used for the various components of the batteries, including packaging materials, anode and cathode materials, polymer electrolyte materials, and current collector and/or current collector tab materials, are described above including, for example, in U.S. Pat. Nos. 5,057,385; 5,326,653; and 6,145,280, each of which is incorporated by reference herein in its entirety.

According to some embodiments, the sealing material comprises a polymer selected from the group consisting of acrylics, ethylene acrylic acid (EAA) copolymers, ethylene and ethyl acrylate (EEA) copolymers, ethylene methacrylic acid (EMA) copolymers, ethylene vinyl acetate (EVA) copolymers, polymethyl acrylate (PMA), acrylonitrite, vinyl chloride polypropylene (VCPP) copolymers, acrylic nitrile-butadiene-styrene (ABS) copolymers, polyethylene (PE), polypropylene (PP) and mixtures thereof.

The method as described herein can also be used to attach the contents in a sealed pouch (e.g., a thin film battery) to the pouch itself.

According to some embodiments, an aperture (e.g., a 2 mm diameter hole) is punched into a strip of thin metallic film such as a battery terminal. The metallic strip is then placed on top of a metallic film such as a battery current collector. The two films are placed into a heat sealable pouch comprising a sealing material layer. The pouch is sealed under heat and pressure. The sealing material (e.g., polymer) flows through the hole in the battery terminal and adheres to the current collector. A mechanical bond between the two metal layers is created while preserving the electrical connection between the non-riveted areas.

The method of attachment described herein can be used instead of other attachment methods such as resistance welding, laser welding, ultrasonic welding, soldering, metallic riveting, crimping and conductive adhesives. Use of the method described herein can eliminate one or more manufacturing steps and works over a much wider set of materials than other methods. In addition, the thickness of the stacked material is not increased by the fastening method.

The thickness of the film being secured to the underlying layer is limited by the thickness of the heat sealing layer and its ability to flow through the aperture in the layer and reach the layer below. The adhesion of the polymer to the substrates is limited by the nature of the polymer and its adhesion to the substrates being used. Adhesion can be improved through the selection of the heat sealing material and the surface treatment of the substrates using methods such as corona or plasma treatment.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A method of attaching a first layer to a second layer, the method comprising:
applying heat and pressure to a laminate comprising the first layer, the second layer and a heat sealing material, wherein a first portion of the second layer comprises one or more apertures and wherein the first portion of the second layer is between the heat sealing material and the first layer;
wherein the heat sealing material flows into and through the one or more apertures in the second layer under the heat and pressure and contacts the underlying first layer thereby attaching the first and second layers together.

2. The method of claim 1, wherein the first layer and the second layer each comprise a metallic layer.

3. The method of claim 1, wherein the sealing material comprises a hot melt adhesive.

4. The method of claim 1, wherein the sealing material comprises a polymer selected from the group consisting of acrylics, ethylene acrylic acid (EAA) copolymers, ethylene and ethyl acrylate (EEA) copolymers, ethylene methacrylic acid (EMA) copolymers, ethylene vinyl acetate (EVA) copolymers, polymethyl acrylate (PMA), acrylonitrite, vinyl chloride polypropylene (VCPP) copolymers, acrylic nitrile-butadiene-styrene (ABS) copolymers, polyethylene (PE), polypropylene (PP) and mixtures thereof.

5. An article of manufacture comprising:
a first layer;
a second layer on and in contact with the first layer wherein the second layer comprises one or more apertures; and
a sealing material on the second layer opposite the first layer, in the one or more apertures in the second layer and on surfaces of the first layer exposed by the one or more apertures, wherein the first and second layers are attached together by the sealing material.

6. The article of manufacture of claim 5, wherein the sealing material is a hot melt adhesive.

7. The article of manufacture of claim 5, wherein the sealing material comprises a polymer selected from the group consisting of acrylics, ethylene acrylic acid (EAA) copolymers, ethylene and ethyl acrylate (EEA) copolymers, ethylene methacrylic acid (EMA) copolymers, ethylene vinyl acetate (EVA) copolymers, polymethyl acrylate (PMA), acrylonitrite, vinyl chloride polypropylene (VCPP) copolymers, acrylic nitrile-butadiene-styrene (ABS) copolymers, polyethylene (PE), polypropylene (PP) and mixtures thereof.

8. The article of manufacture of claim 5, wherein the first and second layers are electrically conductive and wherein electrical continuity exists between the first and second layers.

9. The article of manufacture of claim 5, further comprising a metallic foil layer, wherein the sealing material is between the metallic foil layer and the second layer.

10. The article of manufacture of claim 5, wherein the second layer is smaller in area than the first layer.

11. The article of manufacture of claim 10, wherein a first portion of the second layer comprising the one or more apertures is on the second layer and wherein a second portion of the second layer extends beyond a periphery of the first layer.

12. The article of manufacture of claim 5, wherein the article of manufacture is a thin film battery.

13. A battery comprising:
a battery cell having a periphery, the battery cell comprising an anode, a cathode and an electrolyte between the anode and cathode;
an anode tab comprising a first portion in electrical contact with the anode and a second portion extending beyond the periphery of the cell;
a cathode tab comprising a first portion in electrical contact with the cathode and a second portion extending beyond the periphery of the cell;
wherein the first portion of the anode tab comprises one or more apertures filled with a heat sealing material thereby securing the anode tab to an underlying layer of the anode; and
wherein the first portion of the cathode tab comprises one or more apertures filled with a sealing material thereby securing the cathode tab to an underlying layer of the cathode.

14. The battery of claim 13, wherein the anode comprises an anode current collector layer and an anode layer and wherein the underlying layer of the anode is the anode current collector layer.

15. The battery of claim 13, wherein the cathode comprises a cathode current collector layer and a cathode layer and wherein the underlying layer of the cathode is the cathode current collector layer.

16. The battery of claim 13, further comprising an upper packaging layer and a lower packaging layer.

17. The battery of claim 13, wherein the sealing material is a hot melt adhesive.

18. The battery of claim 13, wherein the sealing material comprises a polymer selected from the group consisting of acrylics, ethylene acrylic acid (EAA) copolymers, ethylene and ethyl acrylate (EEA) copolymers, ethylene methacrylic acid (EMA) copolymers, ethylene vinyl acetate (EVA) copolymers, polymethyl acrylate (PMA), acrylonitrite, vinyl chloride polypropylene (VCPP) copolymers, acrylic nitrile-butadiene-styrene (ABS) copolymers, polyethylene (PE), polypropylene (PP) and mixtures thereof.
